(19) United States
(12) Patent Application Publication
(10) Pub. No.: US 2026/0338025 A1
(43) Pub. Date: Oct. 29, 2026

(54) RETROFIT MODULE FOR A MOVABLE BARRIER OPERATOR

(71) Applicant: OVERHEAD DOOR CORPORATION, LEWISVILLE, TX (US)

(72) Inventors: Daniel Seymour, Durham, CT (US); Kevin D. Banta, Orem, UT (US)

(21) Appl. No.: 19/187,768

(22) Filed: Apr. 23, 2025

(51) Int. Cl. E05F 15/73; E05F 15/77

(52) U.S. Cl. CPC E05F 15/73; E05F 15/77; E05Y 2400/852; E05Y 2900/132

(57) ABSTRACT

A retrofit module may be configured to interface a sensor and a controller of a movable barrier operator. A first connection may be configured to transmit power to the sensor via a two-conductor wire at a first value and the retrofit module may be configured to determine a change to a second value in response to activity at the sensor. A second connection may be configured to generate a barrier actuation signal to the controller of the movable barrier operator to cause a movable barrier to move in response to the change in the first value.

### TECHNICAL FIELD

The present disclosure relates generally to automatic barrier operator systems for opening and closing movable barriers such as swing doors, slide doors, revolving doors, garage doors, gates, and other moveable barriers, and more particularly to systems, devices, and methods for retrofitting a sensor in place of a two-conductor switch.

### BACKGROUND

Some movable barriers, such as automatic doors, are configured with a barrier operator that opens the barrier using an electromechanical switch, such as a handicap push button. Because it is an electro-mechanical switch, it can typically operate without power from an external source. Thus, there are typically only two wires (i.e., the signal wires) extending between the electromechanical switch and the barrier operator.

However, some switches, such as touchless wave sensor switches, can only operate with access to a power supply. Such touchless wave sensor switches typically operate via four-wires: a first two-conductor wire to power the touchless waves sensor and a second two-conductor wire to transmit an actuation signal to the movable barrier operator. Since the switch is typically a substantial distance from the movable barrier operator, and since the wiring is typically behind or within a wall structure, it can be inconvenient or costly, time-consuming to re-run an additional wiring between the barrier operator and the switch. Thus, there remains a need for effective ways to switch-out a typical electromechanical two-conductor wire switch for a higher functioning four-conductive wire switch, such as a touchless wave sensor switch.

### SUMMARY

Embodiments of the present disclosure include systems, devices, and methods of retrofitting a sensor in place of a two-conductor switch.

In an exemplary aspect, a retrofit module configured to interface a sensor and a controller of a movable barrier operator may include a first connection configured to transmit electric energy to the sensor via a two-conductor wire. The retrofit module may be configured to determine a change from a first value to a second value in response to activity at the sensor, the first value and the second value relating to the electric energy. The retrofit module may further include a second connection configured to generate a barrier actuation signal to the controller of the movable barrier operator to cause a movable barrier to move in response to the change in the first value.

In another aspect, a system for interfacing a sensor and a controller of a movable barrier operator may include the sensor positioned remotely from the movable barrier operator. The system may further include the controller configured to actuate the movable barrier operator to cause a movable barrier to open and close. The system may further include a module configured to transmit electric energy to the sensor. The module may be further configured to determine when a first value changes to a second value, the first value relating to the electric energy. The module may be further configured to send a barrier actuation signal to the controller to cause the movable barrier operator to move the movable barrier in response to the barrier actuation signal.

In another aspect, a method for interfacing a sensor and a controller of a movable barrier may include providing a module. The method may further include connecting the module to the sensor to transmit electric energy. The method may further include configuring the module to determine a change in a first value, the first value relating to the electric energy. The method may further include connecting the module to the controller to send a signal to the controller to cause the movable barrier to move in response to the change in the first value.

In another aspect, a method for retrofitting a wave (touchless) sensor in place of a two-conductor switch for actuating a movable barrier may include unattaching the two-conductor switch from a barrier operator. The method may further include connecting a wave sensor (proximity sensor) to a two-conductor wire. The method may further include connecting a module to the two-conductor wire, the module being configured to detect changes in a first value relating to electric energy and generate a barrier actuation command. The method may further include communicating the barrier actuation command to the barrier operator in response to a change in the first value.

In another aspect, a system for interfacing a sensor and a controller of a movable barrier operator may include the sensor positioned remotely from the movable barrier operator. The system may further include the controller configured to actuate the movable barrier operator to cause a movable barrier to open and close. The system may further include a retrofit module configured to transmit electric energy to the sensor. The retrofit module may further determine when a first value changes to a second value, the first value relating to the electric energy. The system may further include a transmitter configured to interface with the module and to send a barrier actuation signal to a receiver in communication with the controller to cause the movable barrier operator to move the movable barrier in response to the barrier actuation signal.

Additional aspects, features, and advantages of the present disclosure will become apparent from the following detailed description.

### BRIEF DESCRIPTION OF THE DRAWINGS

The accompanying drawing figures incorporated in and forming a part of this specification illustrate several aspects of the disclosure, and together with the description, serve to explain the principles of the disclosure.

FIG. 1 illustrates a perspective view of an example movable barrier operator system, according to some aspects of the present disclosure.

FIG. 2 illustrates an example block diagram of an example movable barrier operator system, according to some aspects of the present disclosure.

FIG. 3 illustrates an example method of retrofitting a sensor in place of a two-conductor wire switch, according to some aspects of the present disclosure.

FIG. 4 illustrates an example block diagram of a conventional movable barrier operator system.

### DETAILED DESCRIPTION

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

Disclosed herein are systems, devices, and methods for retrofitting a sensor switch (also referred to herein as a “sensor”) in place of a two-conductor switch without replacing all the conductor wiring running from the sensor switch to the movable barrier operator. To this end, the present disclosure may teach a retrofit module which may allow the sensor switch to send signals and to receive power using only two wires, thereby reducing cost, time, and/or effort required for retrofitting or upgrading a previously installed two-conductor wire switch.

Touchless wave sensors can be a substantial upgrade from conventional electromechanical switches, as the user can operate a movable barrier, such as a swing door, without physically touching the sensor, which may, for example, limit the spread of germs and other contaminants. However, upgrading an electromechanical switch to a touchless wave sensor has conventionally required retrofitting the existing installation to allow the touchless wave sensor to receive power at the previous location of the electromechanical switch.

In some implementations described herein, a retrofit module may significantly reduce the cost, time, and/or effort required to replace an electromechanical switch with a sensor switch, such as a touchless wave sensor. The retrofit module allows the touchless wave sensor to send signals and to receive power using only two wires. Thus, the touchless wave sensor can be installed at the previous location of the electromechanical switch and be connected to the same two wires which connected to the electromechanical switch to the movable barrier operator. The retrofit module may be positioned near or within the movable barrier operator and may connect to the other end of these two wires and use these two wires to supply power to the touchless wave sensor at a power value. When the touchless wave sensor is activated, the touchless wave sensor generally will require more power. This change in power value can be detected by the retrofit module. Thus, when the retrofit module detects a change in the power value transmitted to the touchless wave sensor, the retrofit module may respond by transmitting a barrier actuation signal to the movable barrier operator to open or close the movable barrier. Thus, the movable barrier may open and/or close in response to a detected change in power used by the touchless wave sensor. Instead of installing a second set of two wires from the touchless wave sensor to the movable barrier operator, the retrofit module can be installed to interface the touchless wave sensor and the movable barrier operator while maintaining only a single set of two wires between the touchless wave sensor and the retrofit module.

It should be understood that any implementations disclosed herein may be used in any application; however, some example applications include but are not limited to automatic swing doors, hospital doors, sanitary touchless doors, doors in low-traffic areas, garage doors.

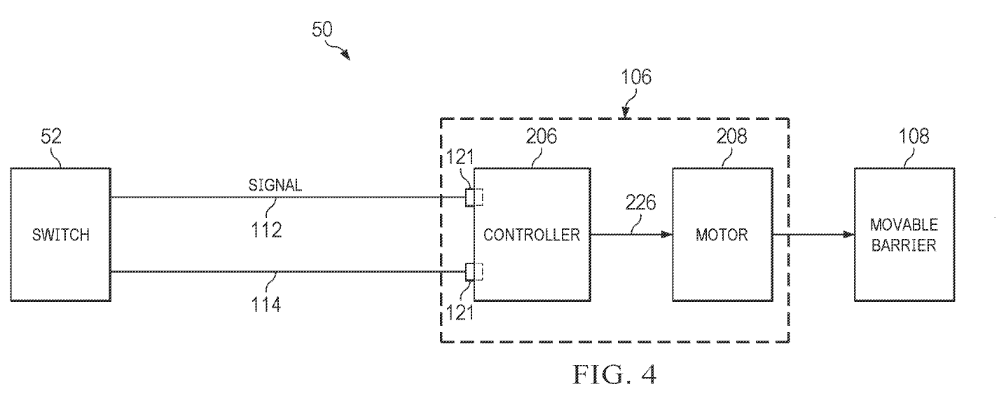

FIG. 4 illustrates a block diagram of a conventional movable barrier system 50. The conventional movable barrier system 50 may include an electromechanical switch 52, first and second power conductors 112, 114, a movable barrier operator 106, and a movable barrier 108. The electromechanical switch 52 may be a push-button switch or a toggle switch that completes a circuit using the power wires 112. Here, the electromechanical switch 52 requires a physical displacement of a portion of the switch, requiring physical contact by a user. In the interest of hygiene and to reduce the spread of bacteria, germs, or viruses, for example, some entities may wish to upgrade their conventional movable barrier system 50 to replace the electromechanical switch 52 with a sensor-operated switch, such as a sensor switch that does not require physical contact by a user. One example of a sensor switch that does not require physical contact by a user is a touchless wave sensor. This upgrade is described herein.

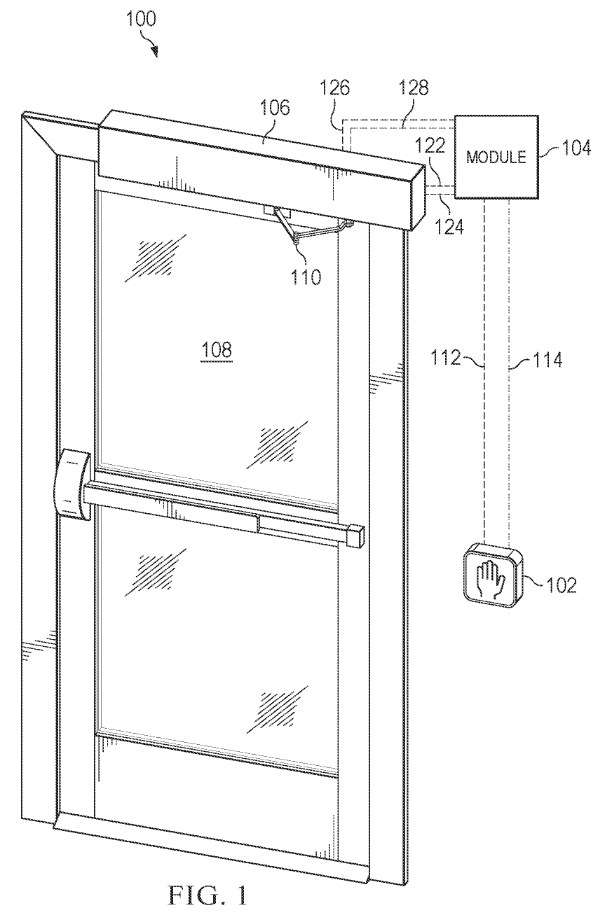

FIG. 1 illustrates a perspective view of an example movable barrier operator system 100 that has been upgraded to have a touchless wave sensor 102 in place of the conventional electromechanical switch 52 (shown in FIG. 4), along with a retrofit module that permits the touchless wave sensor 102 to operate utilizing the first and second power conductors 112 and 114 that were previously used to power the conventional electromechanical switch 52, according to some aspects of the present disclosure. The movable barrier operator system 100 may include at least some or all of a sensor 102, a module 104, a movable barrier operator 106, and a movable barrier 108. The movable barrier operator system 100 may also include a first power conductor 112 and a second power conductor 114 that extend between a first port or input 103 on the sensor 102 and a second port or input 115 on the module 104. In some implementations, the inputs 103 may be power inputs for receiving or transmitting power.

The movable barrier operator system 100 may also include a third power conductor 122 and a fourth power conductor 124 that extend between a third port or input 117 on the module 104 and a fourth port or input 123 on the operator 106, or more specifically, the controller 206.

The movable barrier operator system 100 may also include a first signal conductor 126 and a second signal conductor 128 that extend between a fifth port or input 119 on the module 104 and a sixth port or input 121 on the operator 106, or more specifically, the controller 206. Thus, the sensor 102 may be connected to the module 104 by the first power conductor 112 and/or the second power conductor 114. The module 104 may be connected to the movable barrier operator 106 by the third power conductor 122, the fourth power conductor 124, the first signal conductor 126, and/or the second signal conductor 128. The movable barrier operator 106 may be configured to cause the movable barrier 108 to open and/or to close.

The sensor 102 may receive power from the module 104. In some implementations, the sensor 102 receives power from the module 104 by the first power conductor 112 and/or the second power conductor 114. In some implementations, the sensor 102 may be a touchless sensor and/or a touchless wave sensor. It should be understood that depending on the implementation the sensor 102 may be any type of sensor or sensors including, for example, a contactless sensor, a proximity sensor, a motion sensor, an object sensor, a switch, a button, a handicap push button, a touch sensor, a pressure sensor, a pressure plate, a photosensor, a heat sensor, a voice sensor, a sound sensor, a metal detector, an imaging sensor, and/or any other type of sensing mechanism. In some implementations, the sensor 102 may be positioned a distance, which may be referred to as an accessibility distance, away from the movable barrier 108. The accessibility distance may be a distance sufficient to prevent the user from obstructing the doorway and/or the movable barrier 108 such as about 1 to 20 feet, although other distances are contemplated. In some implementations, the sensor 102 may be positioned a distance, which may be referred to as a retrofit distance, away from the module 104 (and, in some implementations, also the movable barrier operator 106). In some implementations, the retrofit distance may be about 1 to 50 feet. In some implementations, the length of the first power conductor 112 and/or the second power conductor 114 may be exactly or about the same length as the retrofit distance. In some implementations, the sensor 102 may be positioned a distance, which may be referred to as a pre-retrofit distance, away from the movable barrier operator 106. In some implementations, the pre-retrofit distance may be about 1 to 50 feet, although other distances are contemplated.

The first power conductor 112 and the second power conductor 114 may connect to respective power inputs 103 on the sensor 102. It should be understood that in some implementations, the movable barrier operator system 100 may include more than one sensor 102, and each sensor may receive power from the module 104. In implementations with more than one sensor 102, the sensors may be the same type of sensor or different types of sensors. In some implementations, the sensor 102 may include one or more free wires which may be insulated to cover up exposed conducting portions, for example for aesthetic and/or safety purposes. The conducting portions of the free wires may be insulated by any mechanism or mechanism including, for example, with shrinkable plastic tubing, with wire caps, by sealing the one or more free wires in an object such as a wall, and/or with any other suitable insulation mechanism. In some implementations, the module 104 may transmit power wirelessly to the sensor 102 including, for example, using electromagnetic energy.

In some implementations, the sensor 102 may be positioned at a position formerly occupied by an electromechanical switch (e.g., switch 52 in FIG. 4), which may also be referred to as a two-conductor switch. Thus, in some implementations, the first power conductor 112 and the second power conductor 114 may have been formerly used to transmit a signal from the electromechanical switch to the movable barrier operator 106. Thus, in some implementations, the first power conductor 112 and/or the second power conductor 114 may have been formerly coupled with the first signal conductor 126 and/or the second signal conductor 128 at the inputs 121 (as shown in FIG. 4). Thus, in some implementations, the module 104 may be installed by disconnecting the first power conductor 112 and/or the second power conductor 114 from the inputs 121 and then coupling the first power conductor 112 and the second power conductor 114 to the inputs 115 on the module 104. Then, the first signal conductor 126 and/or the second signal conductor 128 may be coupled to the inputs 119 on the module 104 and the inputs 121 on the operator 106, or more specifically, the controller 206.

In some implementations, the module 104 may detect or measure an electric characteristic, which may also be referred to as a value, a value relating to electric energy, an energy characteristic, an electric characteristic value, a state, a condition, and/or any other suitable term. An electric characteristic may refer to any type of characteristic, value, and/or variable relating to and/or for measuring energy and/or electricity including, for example, charge, voltage, current, power, energy, work, magnetic flux, and/or any other suitable characteristic. A change in an electric characteristic may refer to a change to any type of change in characteristic, value, and/or variable relating to and/or for measuring energy and/or electricity including, for example, a change in charge, a change in voltage, a change in current, a change in power, a change in energy, a change in work, a change in magnetic flux, and/or any other suitable change in characteristic. As used herein, the term “power value” may also refer to other values including, for example, current, voltage, or any other suitable value. The module 104 may transmit power at a power value to the sensor 102. Depending on the implementation, the module 104 may be referred to by other terms including, for example, retrofit module, retrofitter, adapter, converter, transformer, interface, junction, bus, and/or any other suitable term. In some implementations, the module 104 may transmit power to the sensor 102 using the first power conductor 112 and the second power conductor 114. The module 104 may be equipped to determine the change in the power value transmitted to the sensor 102 including, for example, detecting an increase in the current or power value and/or a decrease in voltage. When the sensor 102 is activated, the sensor 102 may use a different amount of power, causing the power value transmitted from the module 104 to the sensor 102 to change. In some implementations, when the sensor 102 is activated, the sensor 102 may use more power, causing the power value transmitted from the module 104 to the sensor 102 to increase. The module 104 may detect a change in the power value and send one or more signals, which may be referred to as one or more barrier actuation signals or one or more barrier actuation commands, to the movable barrier operator 106 in response to the change in power value.

In some implementations, the module 104 may determine a change in power value supplied to the sensor 102 by determining that the power value changed to a second power value. In some implementations, the module 104 may determine a change in power value supplied to the sensor 102 by comparing the power value to a threshold value and/or determining the change in power value is outside a pre-determined range. In some implementations, the module 104 may determine an increase in power value supplied to the sensor 102 by comparing the power value to a threshold value and/or determining the change in power value is outside a pre-determined range. It should be understood that the module 104 may measure the power value using any mechanism including, for example, a multimeter, voltmeter, ammeter, and/or any other suitable mechanism. The power value may be determined based on any unit including, for example, volts, amperes (amps), watts, and/or any other unit of measure. In some examples, in some implementations, the module 104 may measure the voltage of the first power conductor 112 and/or the second power conductor 114 for a change in the voltage to determine a change in power value. In additional examples, in some implementations, the module 104 may determine when the change of voltage of the first power conductor 112 and/or the second power conductor 114 reaches a threshold voltage to determine a change in power value. Depending on the implementation, the threshold voltage may be any voltage.

In some implementations, the change in voltage may be a decrease in voltage. In some implementations, the module 104 may measure the amperage of the first power conductor 112 and/or the second power conductor 114 for a change in the amperage to determine a change in power value. In some implementations, the module 104 may determine when the change of amperage of the first power conductor 112 and/or the second power conductor 114 reaches a threshold amperage to determine a change in power value. In some implementations, the module 104 may measure the power in watts of the first power conductor 112 and/or the second power conductor 114 for a change in the power in watts to determine a change in power value. In some implementations, the module 104 may determine when the change of power in watts of the first power conductor 112 and/or the second power conductor 114 reaches a threshold wattage to determine a change in power value. In some implementations, the module 104 may send the one or more signals using the first signal conductor 126 and the second signal conductor 128.

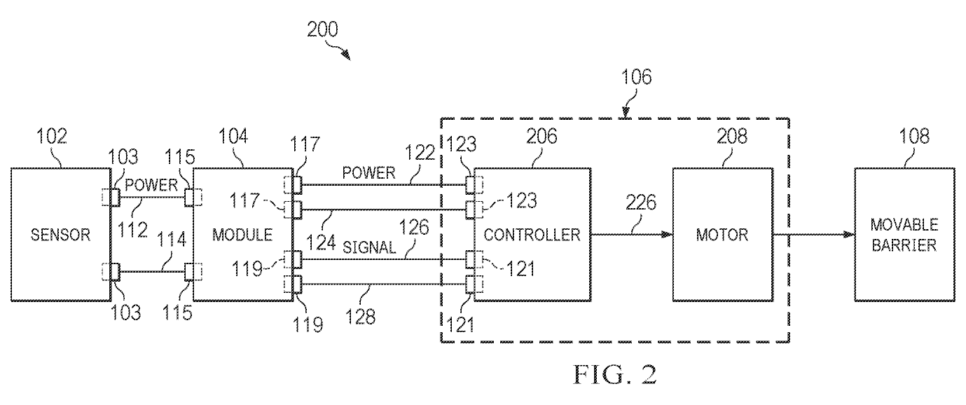

In some implementations, such as shown in FIGS. 1-2, the module 104 may receive power from the movable barrier operator 106. In some implementations, the module 104 may receive power from the movable barrier operator 106 by the third power conductor 122 and the fourth power conductor 124. However, it should be understood that depending on the implementation, the module 104 may receive power from any source or sources, including, for example, electric outlet(s), one or more batteries, solar panel(s), and/or any other power source.

In some implementations, the module 104 may be manufactured with at least some or all of the first power conductor 112, the second power conductor 114, the third power conductor 122, the fourth power conductor 124, the first signal conductor 126, and/or the second signal conductor 128 connected and/or pre-installed. In some implementations, the module 104 may be manufactured with one or more input and/or output ports to couple with and/or connect with at least some or all of the first power conductor 112, the second power conductor 114, the third power conductor 122, the fourth power conductor 124, the first signal conductor 126, and/or the second signal conductor 128. In some implementations, the module 104 may have one or more conductors, such as two wires, extending from the module 104 that may couple with the first power conductor 112 and the second power conductor 114 by any coupling mechanism including, for example, wire connector(s) (e.g., twist-on wire connectors, crimps, push-in wire-connectors, sleeves, tubes, plugs, jacks, etc.), soldering, shrinkable plastic tubing, wire wrapping, and/or any other type of suitable coupling mechanism.

The movable barrier operator 106 may be configured to operate the movable barrier 108. Depending on the implementation, the movable barrier operator 106 may be referred to my other terms including, for example, barrier operator, door actuator, automatic door opener, door opener, automatic door closer, door closer, door control, swing door operator, and/or any other suitable term. The movable barrier operator 106 may be equipped to cause the movable barrier 108 to open and/or close. In the example shown in FIG. 1, the movable barrier operator 106 is an automatic door opener and closer, which may open the movable barrier 108 by actuating the connector 110. However, it should be understood that depending on the implementation, the movable barrier operator 106 may cause the movable barrier 108 to open and/or close in any way as may be discussed further herein. In some implementations, the movable barrier operator 106 may receive the one or more barrier actuation signals sent from the module 104 in response to a change in the power value transmitted to the sensor 102. The movable barrier operator 106 may cause the movable barrier 108 to open and/or close based on the one or more barrier actuation signals sent by the module 104.

The movable barrier 108 may be caused to open and/or close by the movable barrier operator 106. It should be understood that depending on the implementation, the movable barrier 108 may be any type of movable barrier including, for example, a swing door, a slide door, automatic slide door, automatic swing door, a revolving door, a garage door, a gate, and/or any other type of movable barrier.

In some implementations, the first power conductor 112 and the second power conductor 114 may transmit power from the module 104 to the sensor 102. In some implementations, the connection between the module 104 and the sensor 102 and/or the first power conductor 112 and the second power conductor 114 may be referred to as a first connection. In some implementations, the first power conductor 112 and the second power conductor 114 may be a two-conductor wire connecting the sensor 102 and the module 104. In some implementations, the first power conductor 112 and the second power conductor 114 may be two wires, which may be referred to as the first wire and the second wire respectively, connecting the sensor 102 and the module 104. It should be understood that depending on the implementation, any number of conductors may be used to transmit power from the module 104 to the sensor 102 including, for example, one wire, two wires, three wires, and/or four wires.

In some implementations, the third power conductor 122 and the fourth power conductor 124 may transmit power from the movable barrier operator 106 to the module 104. In some implementations, the power transmission connection between the movable barrier operator 106 and the module 104 and/or the third power conductor 122 and the fourth power conductor 124 may be referred to as a third connection. In some implementations, the third power conductor 122 and the fourth power conductor 124 may be a two-conductor wire connecting the module 104 and the movable barrier operator 106. In some implementations, the third power conductor 122 and the fourth power conductor 124 may be two wires connecting the module 104 and the movable barrier operator 106. It should be understood that depending on the implementation, any number of conductors may be used to transmit power from the movable barrier operator 106 to the module 104 including, for example, one wire, two wires, three wires, and/or four wires.

In some implementations, the first signal conductor 126 and the second signal conductor 128 may send one or more signals from the module 104 to the movable barrier operator 106. In some implementations, the signal connection between the module 104 and the movable barrier operator 106 and/or the first signal conductor 126 and the second signal conductor 128 may be referred to as a second connection. In some implementations, the first signal conductor 126 and the second signal conductor 128 may be a two-conductor wire connecting the module 104 and the movable barrier operator 106. In some implementations, the first signal conductor 126 and the second signal conductor 128 may be two wires connecting the module 104 and the movable barrier operator 106. It should be understood that depending on the implementation, any number of conductors may be used to send one or more signals from the module 104 to the movable barrier operator 106 including, for example, one wire, two wires, three wires, and/or four wires. It should be understood that in some implementations, the module 104 may send the one or more signals to the movable barrier operator 106 by another connection including, for example, wireless connection, a wireless local area network which observes IEEE 802.11 protocol (which may be referred to as Wi-Fi®), Bluetooth®, Zigbee®, mobile network, and/or any other type of suitable connection.

In some implementations, a transmitter (not shown) may be positioned at least partially within the sensor 102, positioned at least partially within a housing (not shown) which at least partially contains the sensor 102, positioned adjacent to the sensor 102, positioned at least partially within the module 104, positioned at least partially within a housing which also at least partially contains the module 104, and/or positioned adjacent to the module 104. In some implementations, a receiver (not shown) may be positioned at least partially within the module 104, the movable barrier operator 106, the controller 206, the motor 208, and/or the movable barrier 108 and/or adjacent to the module 104, the movable barrier operator 106, the controller 206, the motor 208, and/or the movable barrier 108. In some implementations, the transmitter may transmit information and/or a wireless signal to the receiver. In some implementations, the information and/or the wireless signal may include information relating to actuation of the sensor 102 and/or the module 104 including, for example, an indication that the sensor 102 and/or the module 104 has been actuated. In some implementations, the information and/or the wireless signal may include information relating to a change in voltage, current, and/or power including, for example, an indication from the sensor 102 and/or the module 104 that a change in voltage, current, and/or power has been detected. The transmitter may communicate with the receiver using any type of communication including, for example, wireless connection, a wireless local area network which observes IEEE 802.11 protocol (which may be referred to as Wi-Fi®), Bluetooth®, Zigbee®, mobile network, and/or any other type of suitable type of communication. The transmitter and/or the receiver may each have one or more antennas including, for example, two antennas. In some implementations, the receiver may actuate the movable barrier operator 106, the controller 206, the motor 208, and/or the movable barrier 108 to open or close the movable barrier 108. In some implementations, the receiver may send a second wireless signal to the transmitter to confirm that a wireless signal from the transmitter was received. In some implementations, the transmitter and the receiver may handshake in order to establish a connection for sending one or more wireless signals. In some implementations, the transmitter may send a wireless signal to the receiver indicating that the sensor 102 is disconnected from the module 104, the movable barrier operator 106, and/or the controller 206 or indicating that the sensor 102 is not receiving sufficient power for the voltage, current, and/or power to be measured. In some implementations, the transmitter and/or receiver may store data relating to a wireless signal transmission in a memory (not shown). These data may be any type of data including, for example, information relating to the status of the movable barrier 108 (e.g., fully open, partially open, and/or closed); the number of times the sensor 102 has been actuated; the change in voltage, current, or power; and/or any other suitable data. In some implementations, the transmitter or the receiver may be capable of communicating with an external server, RFID tag, and/or a mobile device, including, for example, a smart phone, in order to transmit data or transmit a wireless signal to actuate the sensor 102 and/or open or close the movable barrier 108.In some implementations, the transmitter may be connected to one or more of the inputs 115, the inputs 117, and/or the inputs 119. In some implementations, the receiver may be connected to one or more of the inputs 121 and/or the inputs 123. In some implementations, the transmitter and/or the receiver may be a transceiver.

FIG. 2 illustrates an example block diagram 200 of an example movable barrier operator system 100, according to some aspects of the present disclosure. In some implementations, the movable barrier operator 106 may include at least some or all of a controller 206 and a motor 208. In some implementations, the movable barrier operator 106 may further include the module 104, which may receive power and/or send the one or more signals to the controller 206 from within the movable barrier operator 106. In some implementations in which the module 104 is positioned within the movable barrier operator 106, the third power conductor 122, the fourth power conductor 124, the first signal conductor 126, and/or the second signal conductor 128 may be entirely or substantially positioned within the movable barrier operator 106. In some implementations in which the module 104 is positioned within the movable barrier operator 106, the first power conductor 112 and/or the second power conductor 114 may enter one or more openings in the movable barrier operator 106 and may couple with the module 104. In some implementations, a movable barrier operator 106 may be manufactured and/or sold with a module 104 preinstalled inside. In some implementations, the module 104 may be coupled to, adjacent to, and/or near the movable barrier operator 106.

The controller 206 may transmit power to the module 104 and/or receive the one or more signals from the module 104. In some implementations, the controller 206 may transmit power to the module 104 by the third power conductor 122 and the fourth power conductor 124. In some implementations, the module 104 may send the one or more signals to the controller 206 by the first signal conductor 126 and the second signal conductor 128. The controller 206 may be equipped to cause the motor 208 to start and stop. In some implementations, the controller 206 may be coupled to the motor 208 by an actuator 226. In some implementations, the controller 206 may adjust the motor 208 between a forward setting, neutral setting, and/or reverse setting where the forward setting causes the motor 208 to open and/or close the movable barrier 108, the neutral setting causes the motor 208 to stop, and the reverse setting causes the motor 208 to close and/or open the movable barrier 108. In some implementations, the controller 206 may cause the motor 208 to open the movable barrier 108, and the movable barrier 108 may close automatically by, for example, gravity and/or a biasing mechanism such as a spring or a hydraulic door closer.

In some implementations, the motor 208 may open and/or close the movable barrier 108 when actuated by the controller 206. In the example shown in FIG. 1, the motor 208 may open and/or close the door using an automatic door opener and closer attached to the movable barrier 108. However, it should be understood that depending on the implementation, the motor 208 may open the movable barrier 108 with any mechanism including, for example, a wound cable, a track, an axel, a piston, a belt, a chain, a jackshaft, a trolley, and/or any other movable barrier opening mechanism.

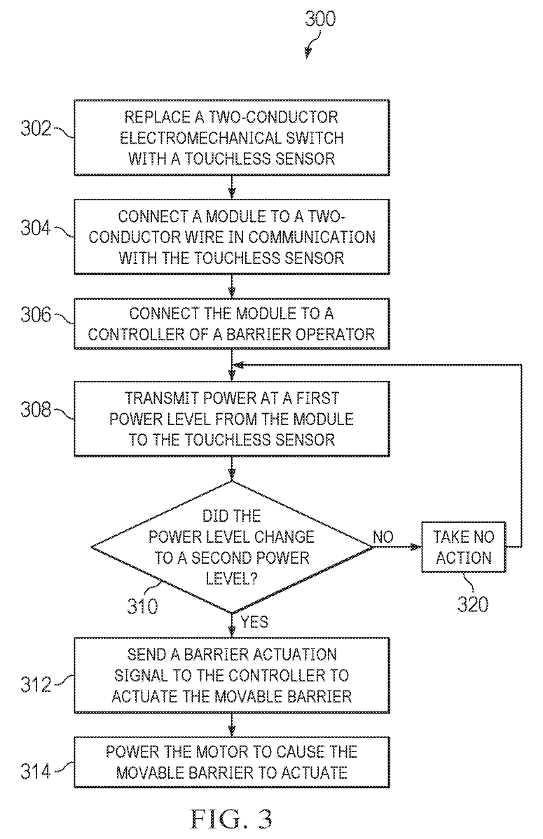

FIG. 3 illustrates an example method of retrofitting a sensor 102 in place of a two-conductor switch, according to some aspects of the present disclosure. In some implementations, the method 300 may be a method for retrofitting a wave sensor 102 in place of a two-conductor switch for actuating a movable barrier 108. At process 302, a two-conductor electromechanical switch may be replaced with a touchless sensor 102. This may include disconnecting the conventional electromechanical switch (e.g., the switch 52 in FIG. 4) from power conductors 112, 114, and connecting the wave sensor 102 to the power conductors 112, 114 at the inputs 103. At process 304, a module 104 may be connected to the two-conductor wire 112, 114 in communication with the touchless sensor 102. This may be done at inputs 115. At process 306, the module 104 may be connected to a controller 206 of a movable barrier operator 106. This may include connecting power conductors 122, 124 to ports or inputs 117 on the module 104 and the ports or inputs 123 on the controller 206. This may also include connecting signal conductors 126, 128 to ports or inputs 119 on the module 104 and the ports or inputs 121 on the controller 206. As noted herein, any of the power conductors 122, 124 or the signal conductors 126, 128 may be already hard wired to the module 104, or in other embodiments, hard-wired to the controller 206.

At process 308, the module 104 may transmit power at a first power value from the module 104 to the touchless sensor 102.

At process 310, the module 104 will determine if the power value changed to a second power value. If the power value changed to a second power value, the method 300 may proceed to process 312. If the power value did not change to a second power value, the method 300 may proceed to process 320.

At process 312, the module 104 may send a barrier actuation signal to the controller 206 to actuate the movable barrier 108. At process 314, the controller 206 may power the motor 208 to cause the movable barrier 108 to actuate.

At process 320, no action may be taken. In some implementations, process 320 may return the method 300 back to process 308.

It should be appreciated that any of the processes of method 300 may be completed in any order. It should also be appreciated that some or all optional processes may be completed depending on the implementation. The order of the processes in method 300 may be changed indiscriminately as a movable barrier operator system 100 is retrofitted to install a sensor 102 in place of a two-conductor switch for actuating a movable barrier 108.

In some implementations, the method 300 may include a retrofit method which may include retrofitting the sensor 102 in place of a two-conductor switch for actuating a movable barrier 108. Initially, the two-conductor switch may be unattached from a barrier operator 106 by unattaching the two-conductor switch from the two-conductor wire 112, 114. Then, the sensor 102 may be connected to a two-conductor wire 112, 114. Then, a module 104 may be connected to the two-conductor wire 112, 114. The module 104 may detect changes in voltage, current, or power and generate a barrier actuation command. Then, the module 104 may communicate the barrier actuation command to the movable barrier operator 106 in response to a change in voltage, current, or power. Then, the movable barrier 108 may open or close in response to the barrier actuation command.

It should be appreciated that any of the steps or processes of the retrofit method may be completed in any order. It should also be appreciated that some or all optional steps or processes may be completed depending on the implementation.

Persons skilled in the art will recognize that the apparatus, systems, and methods described above can be modified in various ways. Accordingly, persons of ordinary skill in the art will appreciate that the embodiments encompassed by the present disclosure are not limited to the particular exemplary embodiments described above. In that regard, although illustrative embodiments have been shown and described, a wide range of modification, change, and substitution is contemplated in the foregoing disclosure. It is understood that such variations may be made to the foregoing without departing from the scope of the present disclosure. Accordingly, it is appropriate that the appended claims be construed broadly and in a manner consistent with the present disclosure.

What is claimed is:

1. A retrofit module configured to interface a sensor and a controller of a movable barrier operator, the retrofit module comprising:
a first connection configured to transmit electric energy to the sensor via a two-conductor wire, the retrofit module configured to determine a change from a first value to a second value in response to activity at the sensor, the first value and the second value relating to the electric energy; and
a second connection configured to generate a barrier actuation signal to the controller of the movable barrier operator to cause a movable barrier to move in response to the change in the first value.

2. The retrofit module of claim 1, wherein the sensor is a contactless sensor.

3. The retrofit module of claim 1, wherein the second connection is a wireless connection.

4. The retrofit module of claim 1, wherein the second value is a threshold value, a difference between the first value and the second value being a range.

5. The retrofit module of claim 1, wherein the module determines the change to a second value by determining a change of power, current, or voltage.

6. The retrofit module of claim 1, wherein the two-conductor wire comprises a first wire and a second wire, the first wire and the second wire each configured to transmit power at the first value.

7. A system for interfacing a sensor and a controller of a movable barrier operator, the system comprising:
the sensor positioned remotely from the movable barrier operator;
the controller configured to actuate the movable barrier operator to cause a movable barrier to open and close; and
a module configured to:
transmit electric energy to the sensor ;
determine when a first value changes to a second value, the first value relating to the electric energy; and
send a barrier actuation signal to the controller to cause the movable barrier operator to move the movable barrier in response to the barrier actuation signal.

8. The system of claim 7, wherein the sensor is a contactless sensor.

9. The system of claim 7, wherein the sensor is a wave sensor.

10. The system of claim 7, wherein the second value is a threshold value, a difference between the first value and the second value being a range.

11. The system of claim 7, wherein the module determines when the first value changes to a second value by determining a change of power, current, or voltage.

12. A method for interfacing a sensor and a controller of a movable barrier, the method comprising:
providing a module;
connecting the module to the sensor to transmit electric energy;
configuring the module to determine a change in a first value, the first value relating to the electric energy; and
connecting the module to the controller to send a signal to the controller to cause the movable barrier to move in response to the change in the first value.

13. The method of claim 12, wherein the sensor is a proximity sensor or a wave sensor.

14. The method of claim 12, wherein the module determines the change in the first value by comparing the first value to a threshold value.

15. The method of claim 12, wherein the module determines the change in the first value by determining a change of power, current, or voltage.

16. A method for retrofitting a wave (touchless) sensor in place of a two-conductor switch for actuating a movable barrier, comprising:
unattaching the two-conductor switch from a barrier operator;
connecting a wave sensor (proximity sensor) to a two-conductor wire;
connecting a module to the two-conductor wire, the module being configured to detect changes in a first value relating to electric energy and generate a barrier actuation command; and
communicating the barrier actuation command to the barrier operator in response to a change in the first value.

17. The method of claim 16, further comprising unattaching the two-conductor switch from a barrier operator by unattaching the two-conductor switch from the two-conductor wire.

18. The method of claim 16, wherein the movable barrier is configured to open or close in response to the barrier actuation command.

19. The method of claim 16, wherein the module is configured to detect the change in voltage by at least one of:
comparing the voltage to a threshold voltage; or
detecting a change of power, current, or voltage.

20. A system for interfacing a sensor and a controller of a movable barrier operator, the system comprising:
the sensor positioned remotely from the movable barrier operator;
the controller configured to actuate the movable barrier operator to cause a movable barrier to open and close; and
a retrofit module configured to:
transmit electric energy to the sensor; and
determine when a first value changes to a second value, the first value relating to the electric energy; and
a transmitter configured to interface with the module and to send a barrier actuation signal to a receiver in communication with the controller to cause the movable barrier operator to move the movable barrier in response to the barrier actuation signal.
